(19) United States
(12) Patent Application Publication
(10) Pub. No.: US 2008/0082702 A1
(43) Pub. Date: Apr. 3, 2008

(54) Information-Processing System, Information-Processing Device, Method, Computer-Readable Medium, And Computer Data Signal

(75) Inventor: Kei Ohtsu, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/683,491

(22) Filed: Mar. 8, 2007

(30) Foreign Application Priority Data
Sep. 27, 2006 (JP) 2006262749

(51) Int. Cl. G06F 13/00

(52) U.S. Cl. 710/33

(57) ABSTRACT

An information-processing system, includes: a first information-processing device having: an acquisition section that acquires identification information through a calculation from document data to be printed, the identification information identifying the document data; and a transmitting section that transmits a print request for the document data including the acquired identification information; a printer having: a reception section that receives the print request transmitted from the first information-processing device; and a transmitting section that transmits the identification information included in the print request; and a second information-processing device having: a registration section that registers, in a memory, identification information which is obtained through a calculation from notification target document data, the identification information identifying the notification target document data; a reception section that receives the transmitted identification information from the printer; and a notification section that provides notification when the transmitted identification information matches the registered identification information.

### CROSS-REFERENCE TO RELATED APPLICATIONS

This application is based on and claims priority under 35 USC 119 from Japanese Patent Application No. 2006-262749 filed on Sep. 27, 2006.

### BACKGROUND

1. Technical Field

The present invention relates to an information-processing system, an information-processing device, a method, a computer-readable medium, and a computer data signal.

2. Related Art

A system including a printer is known.

### SUMMARY

According to one aspect of the present invention, there is provided an information-processing system, including: a first information-processing device having: an acquisition section that acquires identification information through a calculation from document data to be printed, the identification information identifying the document data; and a transmitting section that transmits a print request for the document data including the acquired identification information; a printer having: a reception section that receives the print request transmitted from the first information-processing device; and a transmitting section that transmits the identification information included in the print request; and a second information-processing device having: a registration section that registers, in a memory, identification information which is obtained through a calculation from notification target document data, the identification information identifying the notification target document data; a reception section that receives the transmitted identification information from the printer; and a notification section that provides notification when the transmitted identification information matches the registered identification information of the notification target document data.

### BRIEF DESCRIPTION OF THE DRAWINGS

An exemplary embodiment of the present invention will be described in detail based on the following figures, wherein:

FIG. 1 is a block diagram showing a structure of an information-processing system according to an exemplary embodiment of the present invention;

FIG. 2 is a block diagram showing functional structures of a first information-processing device, a printer, and a second information-processing device;

FIG. 3 is a flowchart showing an operation procedure performed by a server when registering identification information of a notification target document for which notification is to be provided;

FIG. 4 shows an example of content registered in a memory;

FIG. 5 is a flowchart showing an operation procedure performed by a client when printing is performed;

FIG. 6 is a flowchart showing an operation procedure performed by a printer when printing is performed;

FIG. 7 is a flowchart showing an operation procedure performed by a server when printing is performed; and

FIG. 8 shows an example of a relationship among content registered in a memory, hash values of documents to be printed, print settings for printing, and presence or absence of notification.

### DETAILED DESCRIPTION

An exemplary embodiment of the present invention will be described with reference to the below drawings.

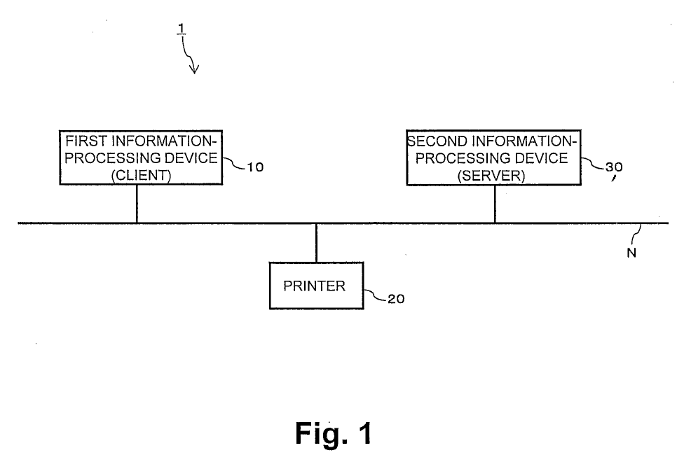

FIG. 1 is a block diagram showing a structure of an information-processing system 1 according to the present exemplary embodiment. As shown in FIG. 1, the information-processing system 1 includes a first information-processing device 10, a printer 20 connected thereto, and a second information-processing device 30 connected thereto. The connections between the above-described devices may be in the form of wired connection or wireless connection. In the example shown in FIG. 1, the devices 10 through 30 are connected to each other through a network N, such as a local area network, the Internet, or the like. It should be noted that multiple first information-processing devices 10 may be connected to the printer 20, and multiple printers 20 may be connected to the second information-processing device 30.

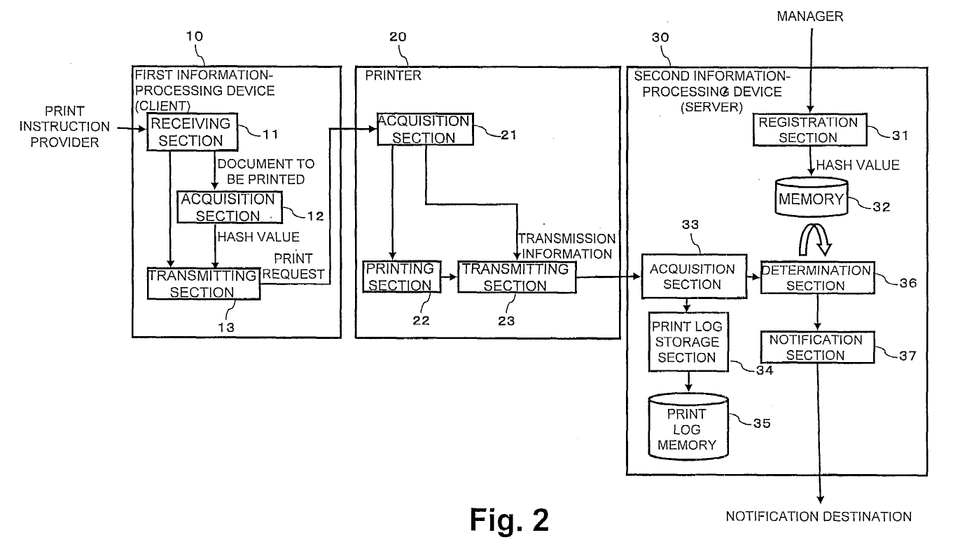

FIG. 2 is a block diagram showing functional structures of the first information-processing device 10, the printer 20, and the second information-processing device 30. In the following, the first information-processing device 10, the printer 20, and the second information-processing device 30 will be described in detail with reference to FIG. 2.

The first information-processing device 10 is a device that issues a print request to the printer 20. In the present exemplary embodiment, the first information-processing device 10 is a computer, and is configured to include hardware resources, such as a CPU (central processing unit), ROM (read only memory), a main memory, an external memory, an input device, a display, a communication device, and the like. Various types of functions of the first information-processing device 10 are achieved by cooperation of hardware resources and software. Specifically, a program stored in a storage medium such as ROM or the like is read by the main memory, and is executed by the CPU, thereby achieving various types of functions of the first information-processing device 10. However, the various types of functions of the first information-processing device 10 may be achieved by hardware only. In the following description, the first information-processing device 10 is referred to as a “client.”

The client 10 has a receiving section 11, an acquisition section 12, and a transmitting section 13. In the present exemplary embodiment, these functional blocks are achieved by a printer driver.

The receiving section 11 receives a print instruction for document data from a user. Here, the document data are digital data, and, in the present exemplary embodiment, are electronic data stored in a computer-readable storage medium, such as, for example, text files, image files, PDF (portable document format) files, and electronic files of other forms. In the present exemplary embodiment, when receiving the print instruction, the receiving section 11 receives print-setting information indicating print settings. The print settings include various settings as are widely known, and may include settings relating to, for example, color mode, pages to be printed, the function of collectively outputting multiple pages on a single sheet of paper (sometimes referred to as an “N-up printing” function), and the like.

The acquisition section 12 performs a predetermined calculation from the document data for which the print instruction is received by the receiving section 11, or, in other words, the document data that are to be printed (hereinafter, simply referred to as “document to be printed”), and thereby acquires identification information identifying the document to be printed. In the present exemplary embodiment, the acquisition section 12 performs a hash operation from the document to be printed, and thereby obtains a hash value of the document to be printed.

The term “hash operation” as used herein refers to an operation in which a hash value “Hn” is obtained by a calculation formula as shown below, where the document file to be printed is represented by “Dn,” and the hash function is represented by “Hash.”

Hn=Hash(Dn)

The term “hash function” as used here refers to an operation method of generating a fixed-length pseudo-random number from a given original.

It should be noted that this calculation is not limited to a hash operation, but may be any operation whereby identification information uniquely identifying the document to be printed can be obtained.

The transmitting section 13 transmits, to the printer 20, the print request for the document to be printed, including the identification information obtained by the acquisition section 12. In the present exemplary embodiment, the transmitting section 13 transmits, to the printer 20, the print request including the following information items (a) through (d) after conversion of the document to be printed into print data, such as PDL (page description language) data or the like.

(a) The print data corresponding to the document to be printed;
(b) The hash value calculated by the acquisition section 12;
(c) The print-setting information received by the receiving section 11; and
(d) Print instruction provider identification information for identifying a user who has issued the print instruction (hereinafter, referred to as “print instruction provider”), such as, for example, a user account, a client IP address, or the like.

It should be noted that the above-described information items (a) through (d) may be transmitted simultaneously or may be transmitted individually at different times. Further, the print-setting information and the print instruction provider identification information included in the above-described information items (a) through (d) may be omitted. Further, the transmitting section 13 may transmit the document to be printed, instead of the print data.

The printer 20 is a device that performs printing in accordance with a print request from the client 10. In the present exemplary embodiment, the printer 20 is configured to include hardware resources, such as an electrophotographic, inkjet, or other type of print engine, a CPU, ROM, a main memory, an external memory, an input device, a display, a communication device, and the like. Various types of functions of the printer 20 are achieved by cooperation of hardware resources and software. Specifically, a program stored in a storage medium such as ROM or the like is read by the main memory, and is executed by the CPU, thereby achieving the various types of functions of the printer 20. However, the various types of functions of the printer 20 may be achieved by hardware only.

The printer 20 has an acquisition section 21, a printing section 22, and a transmitting section 23.

The acquisition section 21 receives and acquires the above-described print request from the client 10.

The printing section 22 prints the document to be printed in accordance with the print request acquired by the acquisition section 21. In the present exemplary embodiment, the printing section 22 generates raster format image data on the basis of the print data included in the print request. Then, on the basis of the generated image data, the printing section 22 prints, on a print medium such as paper or the like, an image corresponding to the document to be printed, according to the print setting indicated by the print-setting information included in the print request.

The transmitting section 23 transmits, to the second information-processing device 30, the identification information of the document to be printed included in the print request acquired by the acquisition section 21. In the present exemplary embodiment, the transmitting section 23 transmits, to the second information-processing device 30, transmission information including the following information items (e) through (h)

(e) The hash value included in the print request;
(f) The printed image data;
(g) History information indicating a history of printing; and
(h) Text information extracted from the printed image data by means of character recognition.

Here, the above-noted history information refers to information indicating, for example, when, by whom, where, and how the printing has been performed, and, in the present exemplary embodiment, includes the following information items (g1) through (g4).

(g1) The date and time when the printing has been performed;
(g2) The print instruction provider identification information included in the print request;
(g3) Information for identifying the printer 20 (for example, a printer name or IP address); and
(g4) The print-setting information included in the print request.

It should be noted that the above-described information items (e) through (h) may be transmitted simultaneously or may be transmitted individually at different times. Further, the image data, the history information, and the text information included in the above-described information items (e) through (h) may be omitted.

The second information-processing device 30 is a device that provides predetermined notification when identification information of a document to be printed, which is obtained from the printer 20, matches with pre-registered identification information. In the present exemplary embodiment, the second information-processing device 30 also has the function of managing print logs. In the present exemplary embodiment, the second information-processing device 30 is a computer, and is configured to include hardware resources, such as a CPU, ROM, a main memory, an external memory, an input device, a display, a communication device, and the like. Various types of functions of the second information-processing device 30 are achieved by cooperation of hardware resources and software. Specifically, a program stored in a storage medium such as ROM or the like is read by the main memory, and is executed by the CPU, thereby achieving the various types of functions of the second information-processing device 30. However, the various types of functions of the second information-processing device 30 may be achieved by hardware only. In the following description, the second information-processing device is referred to as a “server.”

The server 30 has a registration section 31, a memory 32, an acquisition section 33, a print log storage section 34, a print log memory 35, a determination section 36, and a notification section 37.

The registration section 31 registers, in the memory 32, identification information identifying document data for which notification is to be provided (hereinafter, simply referred to as “notification target document”). The identification information is obtained from the notification target document by means of a predetermined calculation.

Here, the notification target document is digital data, and, in the present exemplary embodiment, is electronic data stored in a computer-readable storage medium, such as, for example, text files, image files, PDF files, and electronic files of other forms. For example, the notification target document is a confidential document for which information leakage should be prevented or detected.

In the present exemplary embodiment, the identification information of the notification target document is a hash value obtained by the same hash operation as performed upon acquisition of the identification information of the document to be printed.

In one aspect, the registering section 31 receives from a manager an identification information registration request including the notification target document, calculates a hash value from the notification target document included in the request, and registers the hash value in the memory 32.

In another aspect, the registration section 31 receives from a manager an identification information registration request including a hash value of the notification target document, and registers the hash value included in that request in the memory 32. In this case, the hash value is calculated by, for example, a computer for use by the manager.

In the present exemplary embodiment, the registration section 31 receives from a manager notification conditions corresponding to the notification target document, and registers the notification conditions in the memory 32 in association with the identification information of the notification target document. Here, the notification conditions include conditions relating to, for example, a period during which notification should be performed, a print instruction provider for which notification should be performed, print settings for which notification should be performed, and the like. More specifically, the notification conditions may include the following conditions (A) through (H):

### (A) The year, month, and date of the printing fall within a predetermined period (for example, on or before Sep. 30, 2006);

### (B) The time (hour and minutes) of the printing falls within a predetermined time slot (for example, from 9 a.m. to 8 p.m.);

### (C) The user account of the print instruction provider is a predetermined user account;

### (D) The user account of the print instruction provider is not a predetermined user account;

### (E) The group to which the print instruction provider belongs is a predetermined group;

### (F) The client that has issued the print request belongs to a predetermined network area (for example, a subnet);

### (G) The printer that has received the print request belongs to a predetermined network area; and

### (H) The print setting specified by the print instruction is a predetermined print setting.

Further, in the present exemplary embodiment, the registration section 31 receives from a manager notification destination information corresponding to the notification target document, and registers the notification destination information in the memory 32 in association with the identification information of the notification target document. Here, the notification destination information includes, for example, an electronic mail address, a facsimile number, a telephone number, an IP address, and the like.

It should be noted that the registration section 31 may receive the above-described identification information registration request, notification conditions, and notification destination information from the manager through an input and output device (such as a display or a keyboard) of the server 30, or may receive the above-described identification information registration request, notification conditions, and notification destination information through a communication channel from an information processing device (for example, a computer) for use by the manager.

The acquisition section 33 receives and acquires transmission information from the printer 20.

The print log storage section 34 stores a part or all of the transmission information acquired by the acquisition section 33 as a print log in the print log memory 35. Specifically, the print log storage section 34 stores the history information, text information, hash value, and image data, which are included in the transmission information, in association with each other in the print log memory 35.

The information stored in the print log memory 35 as described above is used, for example, in a manner as described below. That is, upon receipt of a print log supply request, the server 30 supplies the information stored in the print log memory 35 to a request issuer. In this process, the server 30 may receive designation of search conditions, and supply information that matches the designated search conditions. Here, the search conditions include conditions concerning, for example, the print date and time, print instruction provider, printer, print settings, character string, hash value, and the like. Further, the information to be supplied includes, for example, the print date and time, print instruction provider information, printer information, print settings, character strings, hash values, image data, and the like, and the information to be supplied may be designated by the request issuer.

The determination section 36 determines whether or not the identification information of the document to be printed, acquired by the acquisition section 33, matches identification information pre-registered in the memory 32. In the present exemplary embodiment, the determination section 36 determines whether or not the hash value included in the transmission information received from the printer 20 matches any one of hash values of notification target documents pre-registered in the memory 32.

In the present exemplary embodiment, when it is determined that the identification information of the document to be printed matches pre-registered identification information, the determination section 36 further determines whether or not the notification conditions associated with the notification target document in the memory 32 are satisfied.

The notification section 37 provides predetermined notification when the identification information of the document to be printed, acquired by the acquisition section 33, matches pre-registered identification information. In the present exemplary embodiment, the notification section 37 provides predetermined notification when the determination section 36 determines that the identification information of the document to be printed matches identification information pre-registered in the memory 32.

Further, in the present exemplary embodiment, the notification section 37 provides predetermined notification when the determination section 36 determines that the identification information of the document to be printed indicates a notification target document, and that the notification conditions associated with that notification target document are satisfied.

The above-described predetermined notification includes, for example, notifying a preset notification destination for each document or common to all documents (such as a computer, a mobile phone, a fixed phone, a facsimile machine, or the like), notifying the manager or the like through an output device of the server 30 by means of display or sound, and other forms of notification. In the present exemplary embodiment, the notification section 37 provides notification to a notification destination associated with the notification target document in the memory 32. The content of the notification includes, for example, description indicating that the notification target document has become a document to be printed, print date and time, print instruction provider information, printer information of a printer that has performed the printing, print settings, and the like.

It should be noted that a program for use in the above-described devices can be provided in the form stored in a storage medium, such as a CD-ROM or the like, or can also be provided through a communication unit.

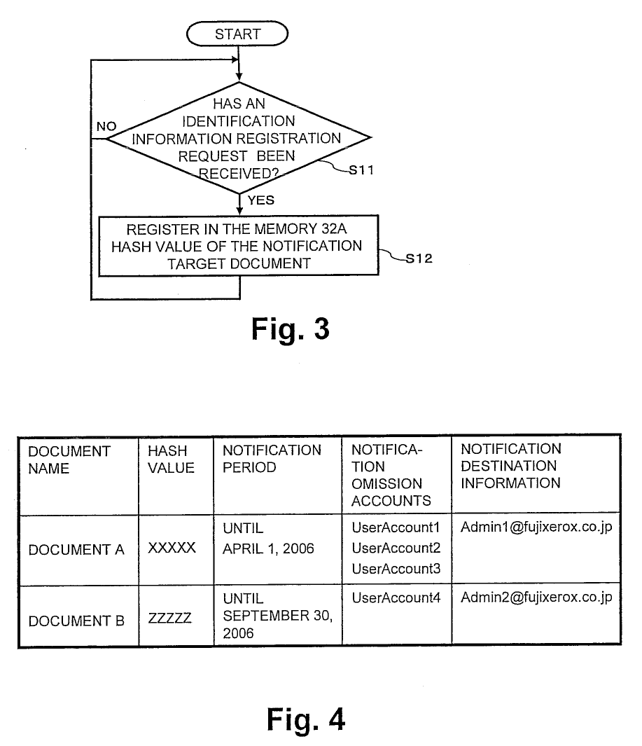

FIG. 3 is a flowchart showing an operation procedure performed by the server 30 when registering identification information of a notification target document. An example of operation of the server 30 performed when registering identification information of a notification target document will be specifically described below with reference to FIG. 3.

The server 30 waits until it receives an identification information registration request (“NO” in step S11), and, when it receives an identification information registration request (“YES” in step S11), registers in the memory 32 a hash value of the notification target document included in that identification information registration request (step S12). In this case, when the identification information registration request includes notification conditions, the server 30 registers the notification conditions in the memory 32 in association with the hash value, and, when the identification information registration request includes notification destination information, the server 30 registers the notification destination information in the memory 32 in association with the hash value.

FIG. 4 shows an example of content registered in the memory 32. Referring to FIG. 4, a document name of a notification target document, a hash value of the notification target document, a notification period during which notification should be performed, notification omission accounts which are user accounts of users for which notification should be omitted, and notification destination information are registered in association with each other.

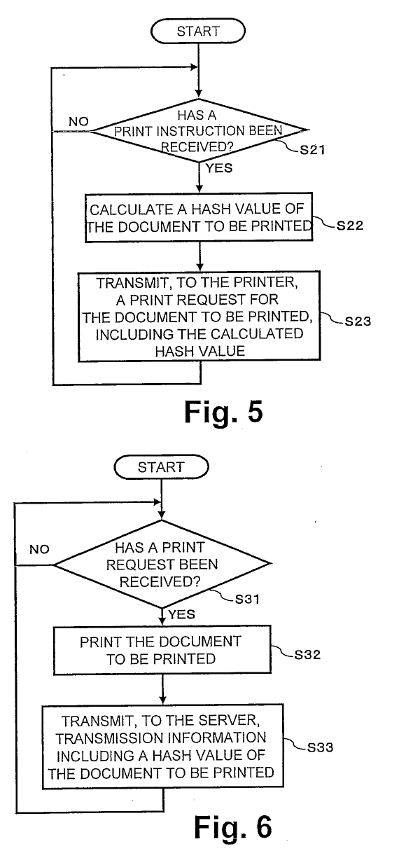

FIGS. 5, 6, and 7 are flowcharts showing operation procedures performed by the client 10, the printer 20, and the server 30, respectively, when printing is performed. An example of operation of the information-processing system 1 performed when printing is performed will be specifically described below with reference to FIGS. 5 through 7.

Referring to FIG. 5, the client 10 waits until it receives a print instruction from a user (“NO” in step S21), and, when it receives a print instruction (“YES” in step S21), calculates a hash value of the document to be printed, which is designated by the print instruction (step S22).

Then, the client 10 transmits, to the printer 20, the print request for the document to be printed (step S23). Here, the print request includes print data corresponding to the document to be printed, print-setting information designated by the print instruction, a user account of a user who has issued the print instruction, and the hash value of the document to be printed.

Referring to FIG. 6, the printer 20 waits until it receives a print request from the client 10 (“NO” in step S31), and, when it receives a print request (“YES” in step S31), converts print data included in that print request into image data, to thereby print and output the image data in accordance with print-setting information included in the print request (step S32).

Then, the printer 20 transmits, to the server 30, transmission information including a hash value of the document to be printed (step S33). Here, in addition to the hash value, the transmission information includes the image data, text information extracted from the image data, the print date and time, and a user account of a user who has issued the print instruction.

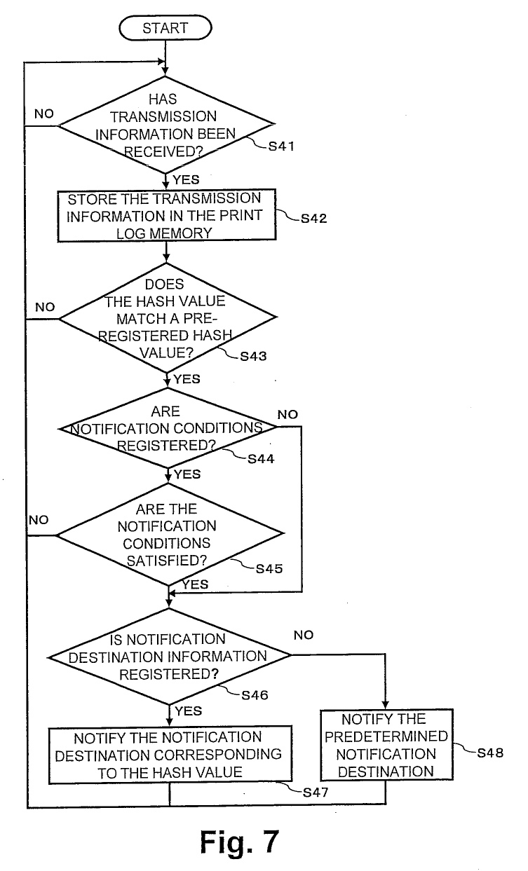

Referring to FIG. 7, the server 30 waits until it receives transmission information from the printer 20 (“NO” in step S41), and, when it receives transmission information (“YES” in step S41), stores the transmission information in the print log memory 35 (step S42).

Then, the server 30 determines whether or not the hash value included in the transmission information matches a hash value pre-registered in the memory 32 (step S43).

When it is determined that the hash value does not match a registered hash value (“NO” in step S43), no notification is provided, and processing returns to step S41.

On the other hand, when it is determined that the hash value matches a registered hash value (“YES” in step S43), the server 30 determines whether or not notification conditions corresponding to the hash value are registered in the memory 32 (step S44).

When it is determined that the notification conditions are not registered (“NO” in step S44), processing proceeds to step S46.

On the other hand, when it is determined that the notification conditions are registered (“YES” in step S44), the server 30 determines whether or not the notification conditions are satisfied (step S45). Specifically, the server 30 refers to registered content as shown in FIG. 4, and, for example, in cases where, when the hash value is “XXXXX,” the print date and time included in the transmission information are on or before Apr. 1, 2006, and a user account included in the transmission information does not correspond to any of “UserAccount1,” “UserAccount2,” and “UserAccount3,” determines that the notification conditions are satisfied, and, in the other cases, determines that the notification conditions are not satisfied.

When it is determined that the notification conditions are not satisfied (“NO” in step S45), no notification is provided, and processing returns to step S41.

On the other hand, when it is determined that the notification conditions are satisfied (“YES” in step S45), processing proceeds to step S46.

In step S46, the server 30 determines whether or not notification destination information corresponding to the above-described hash value is registered in the memory 32.

When it is determined that the notification destination information is not registered (“NO” in step S46), the server 30 notifies a predetermined notification destination for use when the notification destination information is not registered that the notification target document has become a document to be printed (step S48).

On the other hand, when it is determined that the notification destination information is registered (“YES” in step S46), the server 30 notifies a notification destination corresponding to the hash value, that the notification target document has become a document to be printed (step S47).

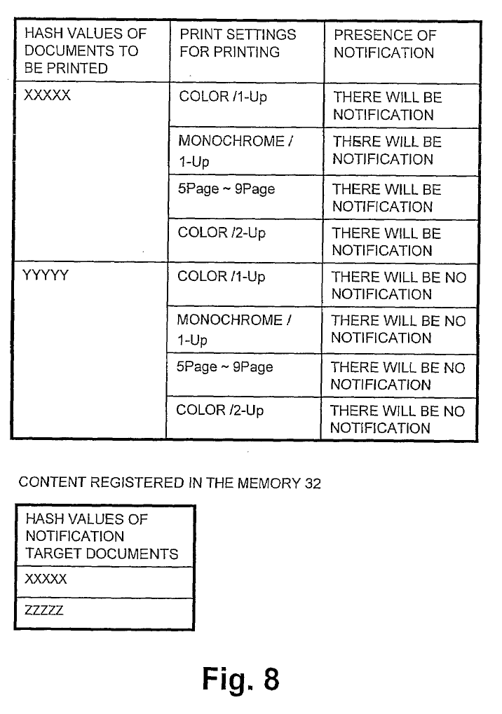

FIG. 8 shows an example of a relationship among content registered in the memory 32, hash values of documents to be printed, print settings for printing, and the presence of notification. Referring to FIG. 8, “XXXXX” and “ZZZZZ” are registered in the memory 32 as hash values of notification target documents, and no notification conditions are associated with any of the hash values. In this case, notification is performed irrespective of print settings when a hash value of a document to be printed is “XXXXX,” and notification is not performed irrespective of print settings when a hash value of a document to be printed is “YYYYY.” As described, when no notification conditions regarding print setting are set, irrespective of print settings, notification is performed in cases where a notification target document has become a document to be printed, and notification is not performed in the other cases.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

For example, although in the above-described exemplary embodiment notification is provided after printing is performed, printing may be performed after notification is provided. As such, notification indicating that a particular document has been printed may be provided, and notification indicating that a print instruction has been issued in connection with a particular document may be provided.

Further, although the above-described exemplary embodiment shows a case where identification information of a document to be printed and identification information of a notification target document are calculated by means of the same function, the two pieces of identification information may be calculated using mutually different functions if it is possible to verify the identity of the document to be printed and the notification target document. For example, when H2(D)=f{H1(D)} holds for given document data D with respect to hash functions H1 and H2, a hash value of a document to be printed may be obtained using the hash function H1, and a hash value of a notification target document may be obtained by means of the hash function H2. In this case, a situation in which a hash value of a document to be printed is “h” and a hash value “f(h)” is pre-registered substantially corresponds to a case where “the hash value of the document to be printed matches a pre-registered hash value.”

Further, identification information of a document to be printed may be calculated by the printer 20. Further, predetermined notification may be performed by the client 10 or the printer 20.

Further, the printer 20 may receive a print instruction for a document to be printed, from a user through an input and output device (for example, a touch panel) of the printer 20, and read and print the document to be printed, from a storage medium (for example, an external memory of the printer 20, a transportable storage medium inserted into the printer 20, or a computer present on a network). In this structure, it is suitable if identification information of a document to be printed is calculated by the printer 20.

It should be noted that the hardware structure shown in FIG. 1 is one example structure, and the present invention is not limited to the structure shown in FIG. 1, but may have any other suitable structure in which the features described in the above-described exemplary embodiment are provided. For example, the program may be installed in a personal computer, or may be installed in a mobile phone, a personal digital assistant, a copying machine, a facsimile, a scanner, a printer, a multifunction copying machine (a device provided with the functions of a scanner, a printer, a copier, a facsimile, and the like), or the like.

What is claimed is:

1. An information-processing system, comprising:
a first information-processing device having:
an acquisition section that acquires identification information through a calculation from document data to be printed, the identification information identifying the document data; and
a transmitting section that transmits a print request for the document data including the acquired identification information;
a printer having:
a reception section that receives the print request transmitted from the first information-processing device; and
a transmitting section that transmits the identification information included in the print request; and
a second information-processing device having:
a registration section that registers, in a memory, identification information which is obtained through a calculation from notification target document data, the identification information identifying the notification target document data;
a reception section that receives the transmitted identification information from the printer; and
a notification section that provides notification when the transmitted identification information matches the registered identification information of the notification target document data.

2. The information-processing system according to claim 1, wherein the identification information is a hash value.

3. The information-processing system according to claim 1, wherein:
the registration section further registers a condition to provide the notification, and
the notification section provides the notification when the condition is satisfied.

4. An information-processing device, comprising:
an acquisition section that acquires identification information which is acquired through a calculation from document data to be printed, the identification information identifying the document data; and
a notification section that provides notification when the acquired identification information matches pre-registered identification information.

5. The information-processing device according to claim 4, wherein the identification information is a hash value.

6. The information-processing device according to claim 4, wherein
the notification section provides notification when a condition to provide notification is satisfied.

7. An information-processing device, comprising:
an acquisition section that acquires identification information through a calculation from document data to be printed, the identification information identifying the document data; and
a transmitting section that transmits, to a printer, a print request for the document data including the acquired identification information.

8. The information-processing device according to claim 7, wherein the identification information is a hash value.

9. A method for providing notification, the method comprising:
acquiring identification information which is acquired through a calculation from document data to be printed, the identification information identifying the document data; and
providing notification when the acquired identification information matches pre-registered identification information.

10. The method according to claim 9, wherein the identification information is a hash value.

11. A method for transmitting a print request, the method comprising:
acquiring identification information through a calculation from document data to be printed, the identification information identifying the document data; and
transmitting a print request for the document data including the acquired identification information.

12. The method according to claim 11, wherein the identification information is a hash value.

13. A computer-readable medium storing a program causing a computer to execute a process for providing notification, the process comprising:
acquiring identification information which is acquired through a calculation from document data to be printed, the identification information identifying the document data; and
providing notification when the acquired identification information matches pre-registered identification information.

14. The medium according to claim 13, wherein the identification information is a hash value.

15. A computer-readable medium storing a program causing a computer to execute a process for transmitting a print request, the process comprising:
acquiring identification information through a calculation from document data to be printed, the identification information identifying the document data; and
transmitting a print request for the document data including the acquired identification information.

16. The medium according to claim 15, wherein the identification information is a hash value.

17. A computer data signal embodied in a carrier wave for enabling a computer to perform a process for providing notification, the process comprising:
acquiring identification information which is acquired through a calculation from document data to be printed, the identification information identifying the document data; and
providing notification when the acquired identification information matches pre-registered identification information.

18. The computer data signal according to claim 17, wherein the identification information is a hash value.

19. A computer data signal embodied in a carrier wave for enabling a computer to perform a process for transmitting a print request, the process comprising:
acquiring identification information through a calculation from document data to be printed, the identification information identifying the document data; and
transmitting a print request for the document data including the acquired identification information.

20. The computer data signal according to claim 19, wherein the identification information is a hash value.

21. A method for providing notification comprising:
registering identification information which is obtained through a calculation from notification target document data, the identification information identifying the notification target document data;
acquiring identification information through a calculation from document data to be printed, the identification information identifying the document data;
transmitting a print request for the document data including the acquired identification information;
receiving the transmitted print request; and
providing notification when the identification information included in the print request matches the registered identification information of the notification target document data.
